(19) United States
(12) Patent Application Publication
(10) Pub. No.: US 2011/0137913 A1
(43) Pub. Date: Jun. 9, 2011

(54) Systems and Methods for Interest-Driven Stock market Segmentation and Stock Trading

(76) Inventors: Shahzad Bhatti, Renton, WA (US); Jennifer J. Just, Winnetka, IL (US); Matthew N. Hulsizer, Winnetka, IL (US); Brad Goldberg, Seattle, WA (US); Jeffrey Alan Fairman, Seattle, WA (US)

(21) Appl. No.: 12/963,601

(22) Filed: Dec. 8, 2010

Related U.S. Application Data
(60) Provisional application No. 61/267,800, filed on Dec. 8, 2009.
(60) Provisional application No. 61/267,802, filed on Dec. 8, 2009.

(51) Int. Cl. G06F 17/30

(52) U.S. Cl. 707/741; 707/E17.002

(57) ABSTRACT

Systems and methods for indexing and searching companies for use in a stock trading application are provided. Indexing may assign a scoring system based on the several pre-determined factors as well as the data source from which the data has been received. Additionally, the indexing methodology supports the creation of minimarkets of stocks based on a term-based or user interest-based groupings of companies.

### RELATED APPLICATIONS

This application claims the benefit of U.S. Provisional Application No. 61/267,800 filed Dec. 8, 2009 entitled “Systems and Methods For Semantic Database Assisted Stock Trading” and U.S. Provisional Application No. 61/267,802 filed Dec. 8, 2009 entitled “Systems and Methods for Interest-Driven Stock Market Segmentation and Stock Trading:, both of which are hereby incorporated by reference in their entirety.

### BACKGROUND OF THE INVENTION

The present invention generally relates to systems and methods for indexing and searching companies to identify companies for which a user desires to trade stocks.

Prior art company stock searching systems have provided the ability to identify specific companies based on certain obvious groupings such as market capitalization, stock price, and industry. However, such obvious groupings are often at odds with regard to how investors typically prefer to identify the stocks in which they want to trade, but potential stock traders have not had an appealing alternative option to date.

### BRIEF SUMMARY OF THE INVENTION

One or more embodiments of the present invention provide systems and methods for indexing and searching companies for use in a stock trading application are provided. Indexing may assign a scoring system based on the several pre-determined factors as well as the data source from which the data has been received. Additionally, the indexing methodology supports the creation of minimarkets of stocks based on a term-based or user interest-based groupings of companies.

### BRIEF DESCRIPTION OF THE DRAWINGS

FIG. 1 illustrates an indexing system for an interest-driven stock market segmentation and trading system according to an embodiment of the present invention.

FIG. 2 illustrates an index document according to a preferred embodiment of the present invention.

FIG. 3 illustrates a more detailed representation of the indexing performed by the indexer.

FIG. 4 illustrates the process that takes place to provide articles from the news/blogs/press data source to the indexing system of FIG. 1.

FIG. 5 is similar to FIG. 4 and illustrates the process that takes place to provide company profile and financial data to the indexing system of FIG. 1.

FIG. 6 is similar to FIGS. 4 and 5 and illustrates the process that takes place to provide user comments and/or reviews to the indexing system of FIG. 1.

FIG. 7 illustrates the workflow from the messaging middleware of FIGS. 5, 6, and 7 to the indexer of FIG. 1.

FIG. 8 illustrates a dependency diagram for the code structure of the indexing and search system.

FIG. 9 illustrates an search system for an interest-driven stock market segmentation and trading system according to an embodiment of the present invention.

FIG. 10 further illustrates the operation of the query manager.

FIG. 11 illustrates the workflow of the query system of FIG. 10.

FIG. 12 illustrates a use case for a web user.

FIG. 13 illustrates the data sources for creating contents and the document index.

FIG. 14 illustrates an exemplary server and environment layout for the indexing and search systems.

FIG. 15 illustrates a data flow diagram for minimarket indexing according to a preferred embodiment of the present invention.

FIG. 16 illustrates a minimarket search algorithm.

FIG. 17 illustrates the use of the minimarket concept in selecting and purchasing a stock.

FIG. 18 illustrates an implementation of the minimarket concept on a website.

### DETAILED DESCRIPTION OF THE INVENTION

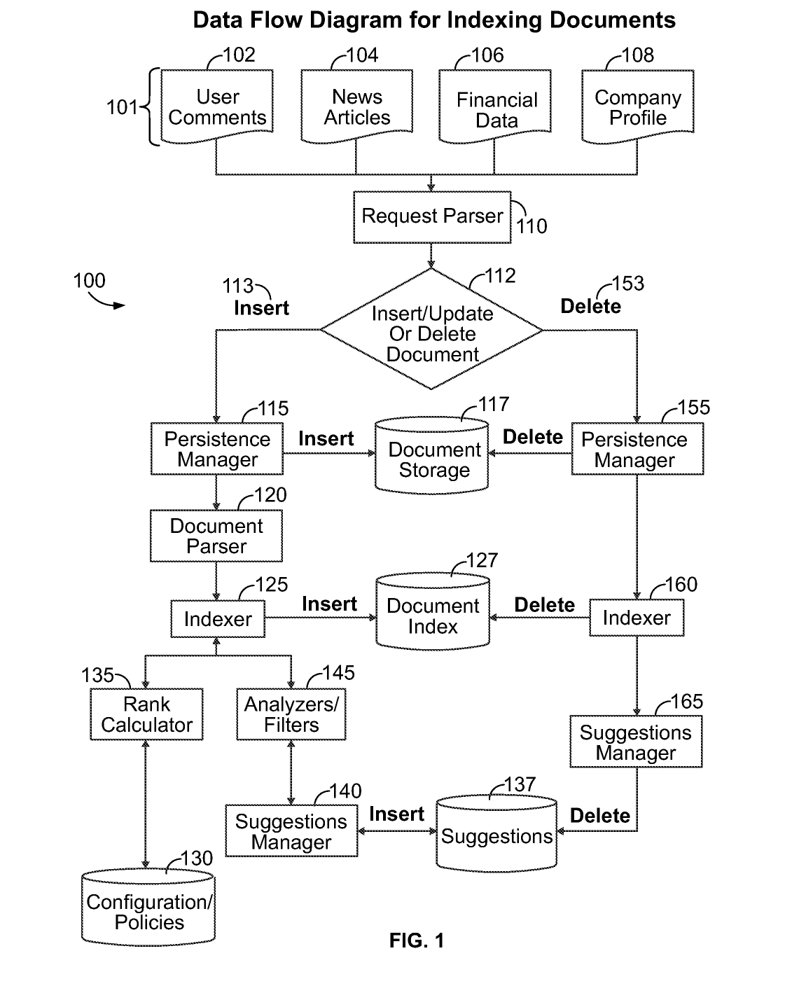

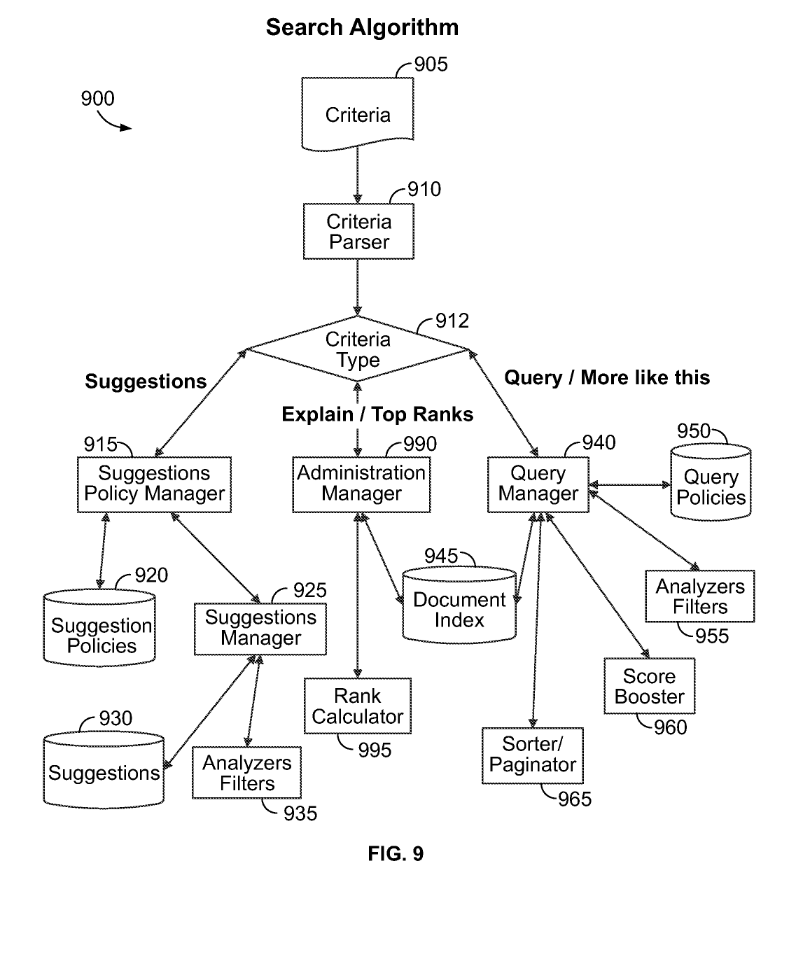

One or more embodiments of the present invention include an indexing system for an interest-driven stock market segmentation and trading system and a search system for an interest-driven stock market segmentation and trading system. The indexing system is discussed beginning in FIG. 1 below. The search system is discussed beginning in FIG. 9 below.

FIG. 1 illustrates an indexing system 100 for an interest-driven stock market segmentation and trading system according to an embodiment of the present invention. The indexing system 100 includes data sources 101, a request parser 110, an insertion pathway 113, a deletion pathway 153, a document storage database 117, a document index database 127, and a suggestions database 137.

In general, in the indexing system 100, data sources 101 are passed to a request parser 110 which determines whether the data source is being added to or removed from the document storage database 117, document index database 127, and suggestions database 137, and routes the data source 101 appropriately. The data source 101 is then added to or removed from the databases 117, 127, 137 which causes dynamic updates to the system's scoring and rankings furthermore updating the company indexing as further detailed below.

Turning now to the data sources 101, the first data source is user comments 102. User comments 102 may be user comments from the site implementing the present indexing system or from some other site. For example, the user comments may be scraped or otherwise acquired from a third party site.

The next data source 101 is news articles 104. The news articles may be from any news source or from multiple news sources, for example Wall Street On Demand or Midnight Trader.

The next data source 101 is financial data 106. The financial data 106 may be received from any financial data source or from multiple financial data sources, for example CapitalIQ.

The next data source 101 is company profiles 108. The company profiles 108 may be received from any company profile data source or from multiple company profile data sources. For example, the company profiles may be received from CapitalIQ or from Bloomberg, or from a company's filing statements such as 10K or 10Q.

Additionally, the company profiles 108 may be manually coded. If the company profiles 108 are manually coded, the company profiles preferably include information about label tags or key words. As further discussed below, such labels or tags may be used below as part of the indexing system. Additionally, company profile information may be ranked higher than other data sources 101, as further discussed below, especially if the company profile information is manually coded.

As further discussed below, each of the data sources 101 above is associated with a different ranking in the indexing system. The ranking is typically influenced by both the type of data source 101 and the content of the data source, as further described below.

The indexing is preferably dynamic in that it updates over time. Comments are preferably added real-time and update scoring and indexes. Each data source preferably behaves in this manner. The upshot is that relevance is impacted with new information thus driving results to be either scored higher or lower.

Returning to FIG. 1, the four data sources 101 are passed to a request parser 110. The request parser 110 determines which type of request the data source 101 is associated with. For example, a new article 104 may be received in association with a delete request to delete the news article 104 from the databases 117, 127, 137. Alternatively, a company profile 108 may be received by the request parser 110 with an associated command to add the company profile 108 to the databases 117, 127, 137.

As shown in FIG. 1, once the request parser 110 receives the data and the associated command, the request parser determines, at step 112, which type of command is associated with the data. For example, an insert/update command or a delete command may be associated with the data.

An insert/update command is an instruction to process and insert the data into the databases 117, 127, 137, as further described below. An update command updates data that is already present in the databases by substituting new data for the previously stored data. For example, if a new company profile is received, the data stored in the databases is updated to reflect the new company profile by use of the update command. Finally, the delete command is an instruction to process and delete the data from the databases 117, 127, 137 as further described below.

If the request parser 110 determines at step 112 that an insert command has been received, the system 100 proceeds to implement the insert pathway 113. First, the data from the data source is passed to the persistence manager 115. At the persistence manager 115, a copy of the original document received from the data source 101 is placed in the document storage database 117. The copy stored in the document storage database may be retrieved later if desired, as described below. The document parser 115 additionally preferably checks what kind of document the original document is. Additionally, as further described below, the dimensions of the information that are determined from these different sources may have different types of ranking, so the way document is stored may be relevant.

Next, the persistence manager 115 passes a copy of the original document to the document parser 120. At the document parser 120, the document is parsed. For example, a document received from Capital IQ might have information about the company or description of a company's goods. Consequently, the document is parsed to identify the type of information that has been found in the document in order to help construct the index, as further described below.

At the indexer 125, the parsed document is received from the document parser 120. Alternatively, the individual parsed data may be received from the document parser 120. At the indexer 125, the parsed data is paired with a data type to form an standardized index document developed from the original document received from the data source.

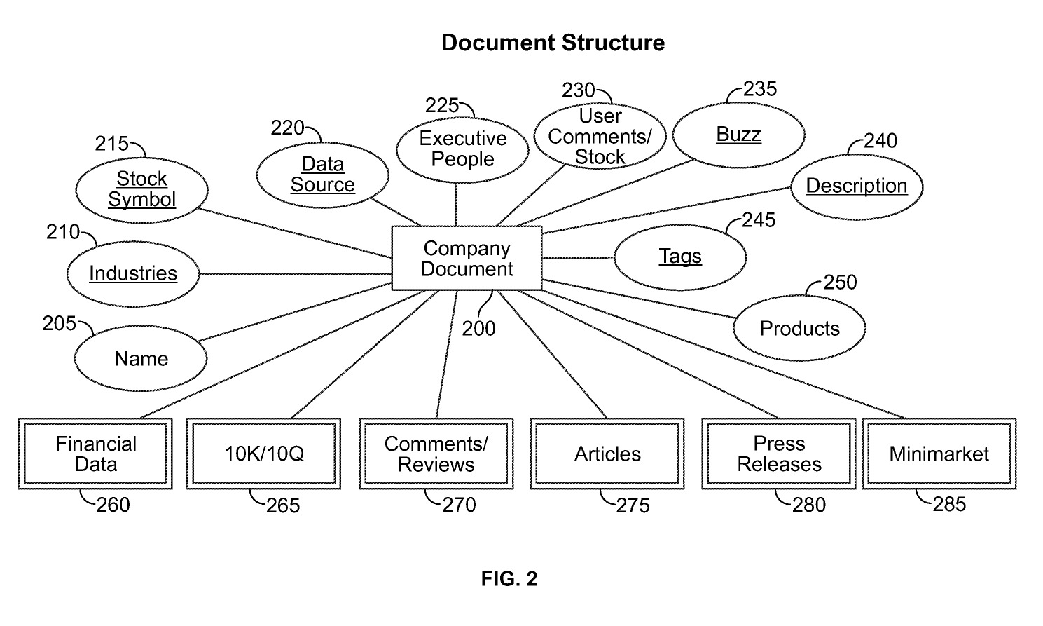

FIG. 2 illustrates an index document 200 according to a preferred embodiment of the present invention. As shown in FIG. 2, the index document 200 includes several fields 205-250 and also includes a listing of data sources 260-285. Not all fields or data sources may be present in each index document.

Turning now to the listing of fields 205-250, the first field is the “name” field 205 which includes the name of the company. The next field is the “industries” field 210 which includes one or more industries that are associated with the company. The next field is the stock symbol field 215 which includes one or more stock symbols associated with the company. The next field is the data source field 220 which identifies the source of the data that is contained in the company document 200. The next field is the executive people field 225 which lists executive people that may be associated with the company. The next field is the user comment/stock field 230 which may be used to identify any user that may bet trading actual or simulated stock in the company or may have made a comment with regard to the company on the present website or on a website that has been scraped by a data sources. The next field is the buzz field 235 which may include buzz about a company including tweets or other social media mentions of the company, or may also include data with regard to the frequency of news mentions associated with the company. The next field is the description field 240 which may include a description of the company. The next field is the tags field 245 which may include tags associated with the company. The next field is the products field 250 which may include products associated with the company. Further, the products may be delineated by type of product, such as “shoes” for example, and any trademark associated with the product, such as “Air Jordan” for example.

Turning now to the listing of data sources 260-285, the data sources include financial data 260, 10K and/or 10Q data 265, comments and/or review 270, articles 275, press releases 280, and the mini-market 285, as further described below. One or more of the data sources 260-285 may provide data that is indexed and placed into the company document 200.

Returning now to the indexing system 100 of FIG. 1, the indexer 125 takes the parsed data and inserts the parsed data into the company document as described in FIG. 2. The company document 200 is then placed in the document index 127. In an “insert” example wherein the company document 200 may not have previously existed, the indexer also creates the company document prior to adding the data to the fields in the company document. In an “update” example wherein the company document may have previously existed, the indexer typically just updates the fields of the company document by adding and/or replacing data in one or more fields of the company document.

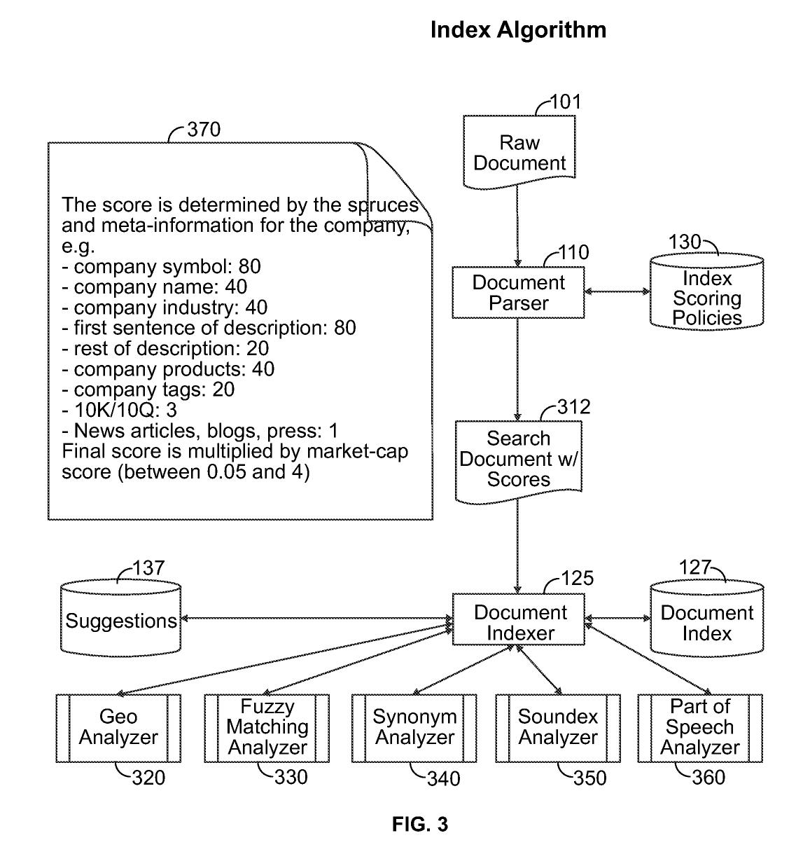

Additionally, as further described below with regard to FIG. 3, configuration or policy information is passed from a configuration/policies database 130 to a rank calculator 135 and then to the indexer 125. Additionally, the rank calculator 135 may calculate a ranking and pass it to the indexer. Additionally, the communication between the indexer 125, rank calculator 135, and configuration/policies database is bidirectional.

Similarly, suggestions may be passed from the suggestions database 137 to the suggestions manager 140 and from there to the analyzers/filters 145 and eventually to the indexer 125. Additionally, the communication between the indexer 125, analyzers/filters 145, suggestions manager 140 and suggestions database 137 is bidirectional.

Turning now to FIG. 3, FIG. 3 illustrates a more detailed representation of the indexing performed by the indexer 125. First, a raw document is received from a data source 101. The document is then passed to the document parser 110. Further, the document parser 110 received the index scoring policies from the index scoring policies database 130. The document parser then proceeds to search the document with the scores at step 312. Then the searched and parsed document is passed to the document indexer 125.

The document indexer 125 received suggestions from the suggestions database 137 and interacts with several analyzers including a geographical analyzer 320, a fuzzy matching analyzer 330, a synonym analyzer 340, a soundex analyzer 350, and a part of speech analyzer 360. Finally, after indexing the document, the document indexer 125 passes the indexed document to the document index database 127.

An example index scoring policy 370 that may be retrieved from the index scoring policy database 130 is shown in FIG. 3. As shown, the index scoring policy may apply a relative score of 80 for the company symbol, 40 for the company name, 40 for the company industry, 80 for the first sentence of the description, 20 for the rest of the description, 40 for company products, 20 for company tags, 3 for 10K or 10Q, and 1 for news articles, blogs or press. In addition, the final score may be multiplied by a market-cap score between 0.05 and 4. The results of the multiplication cause larger companies to be ranked higher.

The suggestions database 137 preferably stores any related terms to the term or company being indexed. For example, the product of one company may be associated with the product of another company in the suggestions database 137. Preferably, the associations are automatically created from the content itself. The suggestions preferably support a feature so that, if a user is typing in the website a product, as they are typing each letter of that product, a drop down menu of terms associated with the typing is displayed. Additionally, suggestions may be loaded into the database from the document indexer. For example, suggestions may be based on the frequency of a term appearing in a document with another term.

Turning now to the geographical analyzer 320, the geographical analyzer 320 preferably takes the address information of a company and then determines the latitude and longitude position for the headquarters of the company and associates the company with that location. The location may also be included in a regional location identifier. For example, the location of the company may be used by a user to find all company headquarters within a 5 or 10 mile radius of a given location. Alternatively, the location may be used to find companies in a region such as “southern California” for example.

Turning to the fuzzy matching analyzer 330, the fuzzy matching analyzer 330 determines different misspellings and wild card matches for terms presented to it. The misspellings may then be sent to the document indexer to assist in scoring and/or indexing the document. The fuzzy matching analyzer 330 includes a database of common misspellings

The synonym analyzer 340 is similar to the fuzzy matching analyzer 330 and includes a dictionary of synonyms. The synonyms may be sent to the document indexer to assist in scoring and/or indexing the document.

Similarly, the soundex analyzer 340 may provide a dictionary of related sounds and/or expressions to the document indexer, so that for example, the indexer may identify phonetically matching words.

Finally, the part of speech analyzer 360 provide a dictionary of the part of speech and/or the root of the word. Further, the it may look at the root of the word and index based on that root and may also find words similar to that root.

As described above, one or more of the analyzers may be employed by the document indexer 125 to aid in the construction of the document index. Relating the structures of FIG. 3 to the elements of FIG. 1, FIG. 3 shows the suggestions database 137, document index 127, and analyzers communicating directly with her document indexer 125. Additionally, the index scoring policies 130 are shown as being provided directly to the document parser 110. FIG. 3 thus represents an alternative embodiment of the embodiment of FIG. 1 wherein the suggestions pass from the suggestions database 137 through a suggestions manager 140 and analyzers/filters 145 before arriving at the indexer 125 and the configuration/policies pass through the rank calculator 130 before arriving at the indexer 125.

Returning now to FIG. 1, we now proceed to the delete pathway 153. In the delete pathway, once the request parser 110 determines at step 112 that a delete operation has been selected, the data from the data source 101 is passed to the persistence manager 155. The persistence manager 155 then finds the copy of the data stored in the document storage database 117 and removes it from the database. Then the data is passed to the indexer 160. The indexer then determines the index for the data and removes the index from the document index database 127. Control then proceeds to the suggestions manager 165, which determines the suggestions based on the data and removes them from the suggestions database.

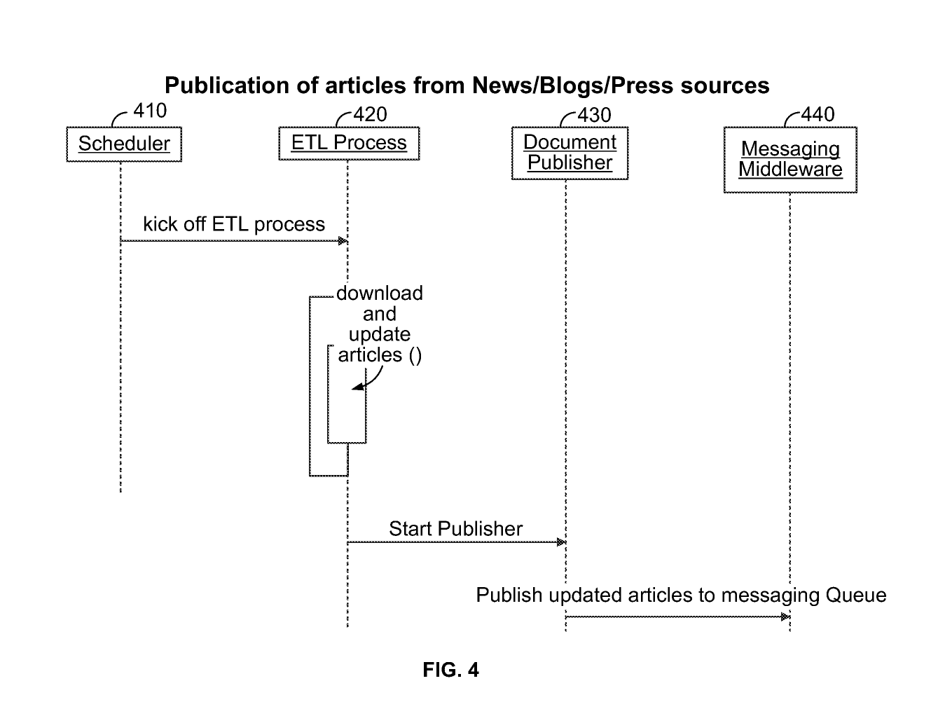

FIG. 4 illustrates the process that takes place to provide articles from the news/blogs/press data source to the indexing system of FIG. 1. As shown in FIG. 4, periodic tasks are performed that obtain data from a News/blogs/process source, such as CapitalIQ, for example. These tasks may be performed up to several times a day, or may be performed daily, weekly, or monthly. The task is initiated by the scheduler 410 which keeps track of the initiation time as it has been set. The scheduler 410 then initiates the Extract/Transform/Load (ETL) process 420 which downloads and updates the articles. The document publisher 430 is then initiated, which publishes the articles to a messaging queue on the messaging middleware. The articles are then passed from the messaging middleware 440 to the document indexer and indexed as described above. In some situations, depending on the format of the article, such as Excel format, the format may be transformed into a more preferable format such as text format, web format, or messaging format.

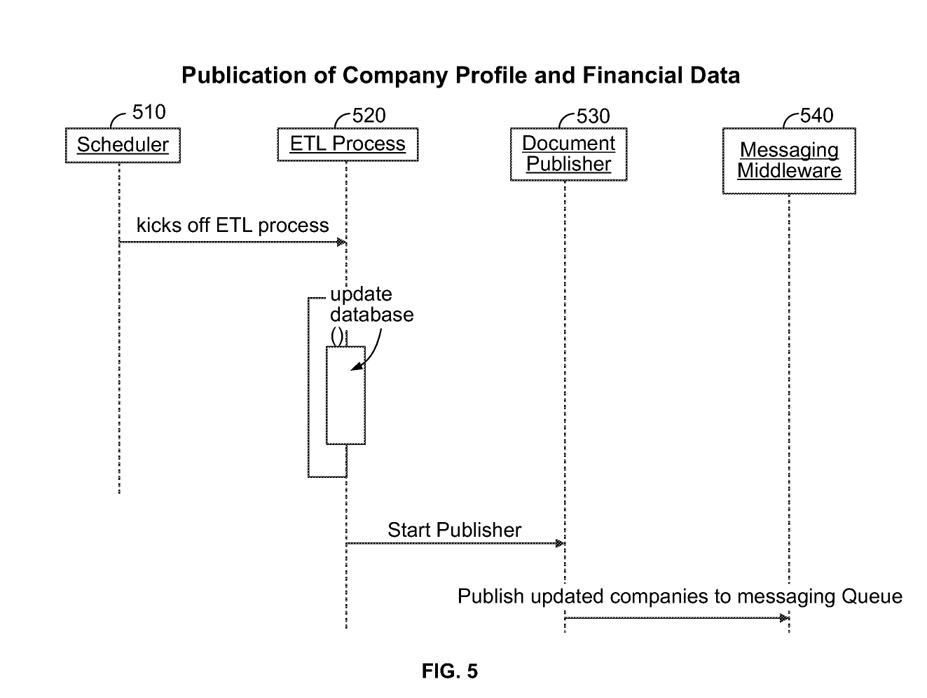

FIG. 5 is similar to FIG. 4 and illustrates the process that takes place to provide company profile and financial data to the indexing system of FIG. 1. As shown in FIG. 5, periodic tasks are performed that obtain data from a company profile and/or financial data source. These tasks may be performed up to several times a day, or may be performed daily, weekly, or monthly. The task is initiated by the scheduler 510 which keeps track of the initiation time as it has been set. The scheduler 510 then initiates the Extract/Transform/Load (ETL) process 520 which downloads and updates the company profile and/or financial data. The document publisher 530 is then initiated, which publishes the company profile and/or financial data to a messaging queue on the messaging middleware. The company profile and/or financial data are then passed from the messaging middleware 540 to the document indexer and indexed as described above. In some situations, depending on the format of the company profile and/or financial data, such as Excel format, the format may be transformed into a more preferable format such as text format, web format, or messaging format.

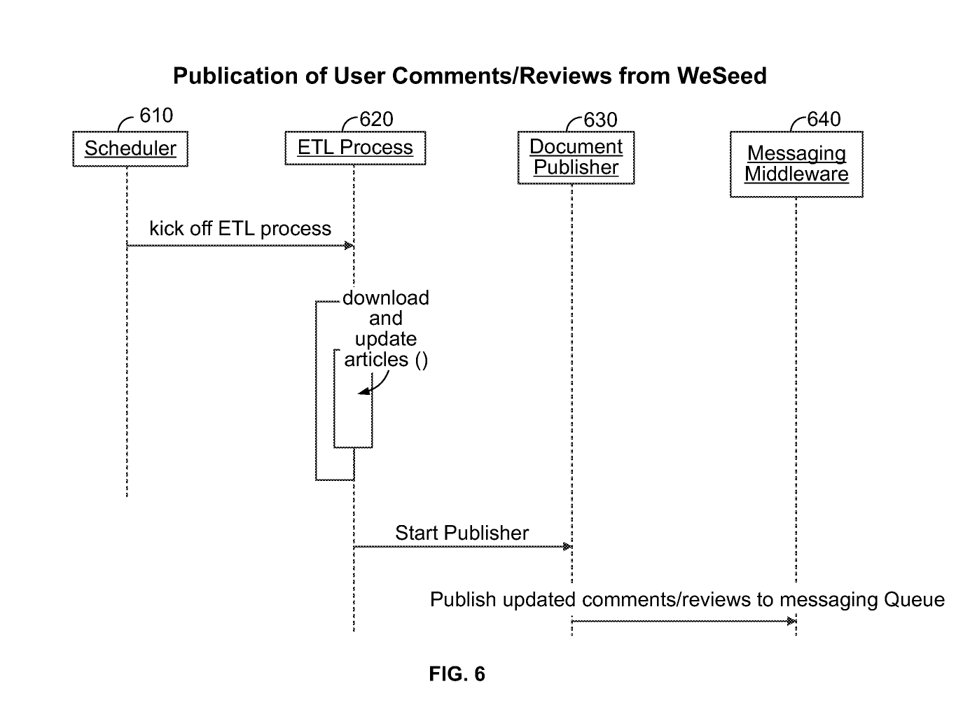

FIG. 6 is similar to FIGS. 4 and 5 and illustrates the process that takes place to provide user comments and/or reviews to the indexing system of FIG. 1. As shown in FIG. 6, periodic tasks are performed that obtain data from a user comments and/or reviews data source. These tasks may be performed up to several times a day, or may be performed daily, weekly, or monthly. The task is initiated by the scheduler 610 which keeps track of the initiation time as it has been set. The scheduler 610 then initiates the Extract/Transform/Load (ETL) process 620 which downloads and updates the user comments and/or reviews. The document publisher 630 is then initiated, which publishes the user comments and/or reviews to a messaging queue on the messaging middleware. The user comments and/or reviews data are then passed from the messaging middleware 640 to the document indexer and indexed as described above. In some situations, depending on the format of the user comments and/or reviews data, such as Excel format, the format may be transformed into a more preferable format such as text format, web format, or messaging format.

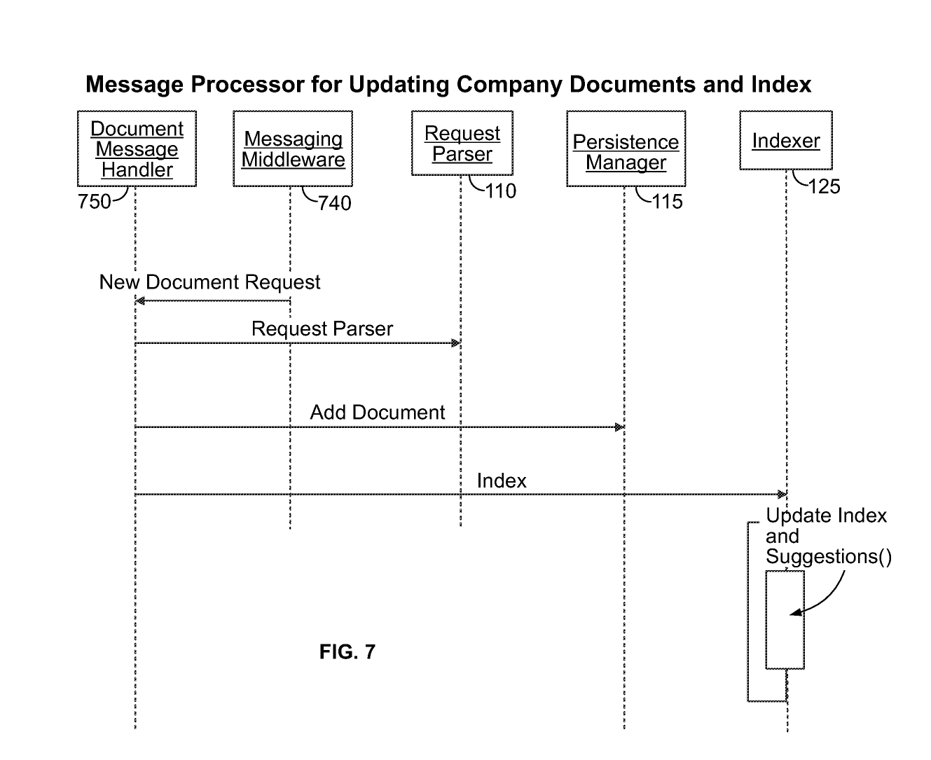

FIG. 7 illustrates the workflow from the messaging middleware 740 of FIGS. 5, 6, and 7 to the indexer 125 of FIG. 1. Starting at the messaging middleware 740, the documents queued at the messaging middleware 740 are read from the queue by the document message handler 750 and then passed to the request parser 110 of FIG. 1. The message handler 750 preferably receives an indication when a new message is present at the messaging middleware 740. Once the message is received at the request parser 110, the request parser checks to see what kind of request is associated with the message, such as a request to “insert” or “add” a document, for example. The request parser then calls the persistence manager 115 to add the document to the document storage database. The document is then also passed to the indexer 125 for indexing.

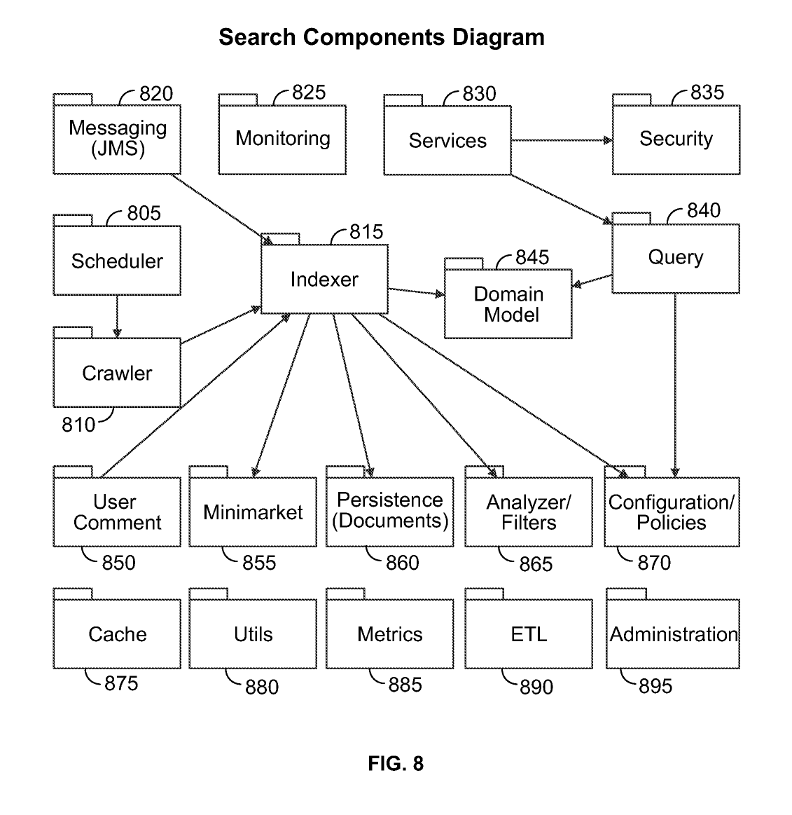

FIG. 8 illustrates a dependency diagram for the code structure of the indexing and search system. As shown in FIG. 8, the code is segmented into several different modules and dependencies between the modules are shown. The first module is the scheduler module 805 which preferably controls the operation of the schedulers 410, 510, 610 that appear in FIGS. 4, 5, and 6 in order to initiate the operation of the index and/or update operations shown in those figures. The next module is the crawler module 810 which is initiated by the scheduler module 805 to crawl the previously determined web locations for documents. For example, the crawler may crawl news websites and or user comments. The crawler then passes its data to the indexer as shown in previous figures. The operation of the indexer is controlled by the indexer module 815.

FIG. 8 also illustrates the messaging module 820 which controls the messaging middleware shown in FIGS. 4-6. As discussed above, the messaging middleware preferably establishes a queue to feed documents to the indexer. The next module is the monitoring module 825 which monitors the operation of the system. For example, the monitoring module 825 may check if the search and/or index is running or not and may send an alert and/or e-mail if it is not. The monitoring module 825 may also perform other diagnostics.

The next module if a services module 830. Services may include an end point that is usable to access the index of a single search, for example through web-based access. The security module 835 controls the operation of common security functions, such as logins and passwords, including who may be allowed to index. The next module is the query module 840 which controls the operation of the searching system, as further described below.

The next module is a domain module 845 which preferably defines common classes for the index and search. For example, a document may be defined as a class and the document may be defined as anything that has a set of matching key value pairs. Further, the key value pairs may store information about the companies such as names, descriptions, products, services, etc.

The next module is the user comment module 850 which controls the operation of user comments on the site. The next module if the minimarket module 855 which controls the operation of the minimarkets which may allow a minimarket to be a data field associated with a company. The next module is the persistence module 860 which controls the operation of the persistence manager as shown in FIG. 1. The next module is the analyzer/filer module 865 which controls the operation of the analyzers 320-360 as shown in FIG. 3. The next module is the configuration/policies module 870 which controls the operation of the configuration/policies database as shown in FIG. 1.

The next module is the cache module 875 which controls caching operation, such as for search optimization and memory so that files may be accessed. Additionally, the caching may store frequently entered keywords to optimize the delivery and user experience. The next module is the utilities module 880 which provides utilities such as helper classes and low level coding operations. The next module is the metrics module 885 which determines metrics for the indexing and/or search operations. For example, the metrics module may determine how long operations take and may report on the timing of operations, such as when operations are taking more time. Additionally, the metric module may determine low long indexing a document took, how long a query takes, and other aspects. The metrics module may be helpful in determining whether certain aspects of the system are able to be or are preferred to be improved or optimized.

The next module is the Extract/transform/load (ETL) module 890 which controls the ETL operation shown in FIGS. 4-6. The final module is the administration module 895 which controls administrative operations such as changing aspects of a document or changing the configuration policies or ranking.

FIG. 9 illustrates a search system 900 for an interest-driven public company search and trading system according to an embodiment of the present invention. First, a user enters search criteria 905 which are then passed to a criteria parser 910. The criteria parser 910 applies Boolean logical operations to the user criteria to parse the criteria query to determine a criteria type 912.

Additionally, as further described below, suggestions may be provided to the user. Suggestions may be provided by the suggestions policy manager 915 based on suggestion policies received from the suggestion policies data base and specific suggestions retrieved from the suggestions database 930 as operated on my the analyzers/filters 935 shown above with regard to FIG. 3 and operating under the control of the suggestions manager 925. For example, the suggestion policies database 920 may include rules that determine what information may be used as a suggestion while the suggestion database 930 may include the suggestions themselves. For example, the suggestions may be used to autofill a search that is being entered by a user as well as present similar search or suggested search results.

Returning to the criteria parser 910, the criteria parser 910 determines a criteria type 912. If the criteria type 912 indicates that suggestions are to be provided, then suggestions are retrieved from the suggestion policy manager 915 as discussed above. Alternatively, if the criteria type indicates that a query has been initiated, then the query operation proceeds to the query manager 940. Finally, if the criteria type indicates that a administrative request has been made, then the operation may proceed to the administration manager 990.

When the criteria type 912 indicates a query and the system proceeds to the query manager 940, the query manager 940 searches the document index for documents relevant to the query. The query manager 940 performs its search in compliance with query policies 950 that it retrieves from the query policy database 950. Additionally, documents retrieved from the document index 945 may be analyzed by the analyzers filers, such as the analyzers shown in FIG. 3.

To clarify, the analyzers/filters shown in FIG. 3 are performing as part of the indexing system. Consequently, they are operating on received documents and data and determining matches between data/documents and company documents. Conversely, in the search system, the analyzers/filters are employed, not to create new matches or add additional data to the company documents, but to determine matches between data entered in a search query and specific company documents. For example, the fuzzy matching analyzer may receive key words and when it is used to search it may use the fuzzy analyzer to determine matches of the variations provided by the fuzzy analyzer. Similarly, if the part of speech analyzer were being employed and the search query that was received including the a word separable by the part of speech analyzer such, the part of speech analyzer then separates the word into its parts of speech and passes the results back to the query manager 940 so that the results may be used in searching the document index 945. For example, “footings” may be broken into “footing” and “foot” or “feet. Further, if a user were to enter “foot” as a search query, the relational aspects stored in the part of speech analyzer may be employed to return additional search results for “foot”. Thus, the relationships provided by the analyzers/filters 955 may be provided to the query manager 940 so that the query manager may return a richer result set.

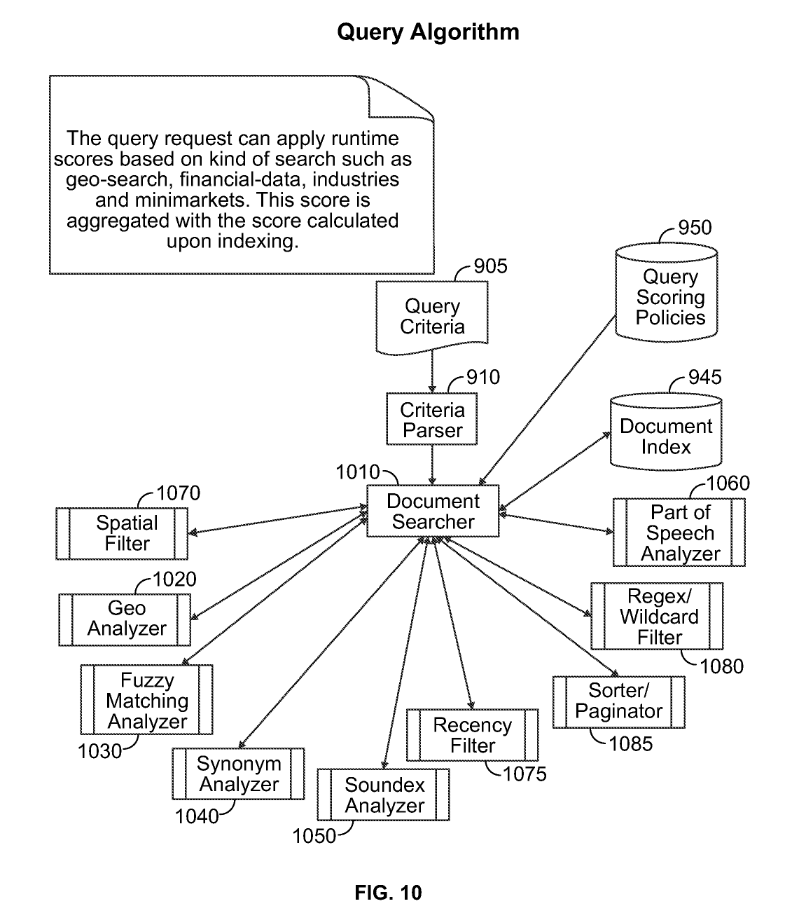

The operation of the query manager is further illustrated in FIG. 10. As shown in FIG. 10, the query criteria 905 is received and passed to the query parser 910, which in turn passes the query to the document searcher 1010, which performs similarly to the query manager 940 of FIG. 9.

As shown in FIG. 10, the document searcher 1010 interacts with and receives results from one or more analyzers/filters 1020-1090. The geographical filter 1020, fuzzy matching filter 1030, synonym analyzer 1040, soundex analyzer 1050, and part of speech analyzer 1060 perform generally similar to the operation discussed above with regard to FIG. 3. Additionally, new analyzer/filters may be employed such as the spatial filter 1070, recency filter 1075, regex/wildcard filter 1080 and the sorter/paginator 1085.

The spatial filter 1070 is similar to the geographic analyzer and can provide results based on the relative spatial locations of the query and the company. The recency filter provides info nation with regard to the recency of the company document, such as how long ago the company document was added to or updated in the company index database. More recently entered or updated documents may be considered more relevant search results. Additionally, older documents such as articles my be deleted or the recency filter may be employed instead so that the older articles are just ranked lower than the newer articles.

The regex/wildcard filter 1080 may be used to return results that represent matches based on the recognition of common expressions or on the use of wildcard characters in the search string of the search time. Finally, the sort/paginator 1085 may be used to break the search results into pages having a certain number of results per page displayed to the user.

Returning to FIG. 9, if the criteria type 912 is an administrative criteria, the administration manager 990 is engaged. For example, the administration manager may be engages to explain the top ranks of a search result for debugging and/or optimizing purposes. For example, certain key words may be entered that should provide known results when the system is operating correctly. If the correct results are not received, then an error may be determined and further information with regard to the error may be obtained. Additionally, the rank calculator 995 may determine a ranking similar to that returned by the query manager 940 as further described below.

Returning to the query manager 940, we note that the query manager 940 accesses the query policies 950. The query policies 950 is a set of configuration policies that are used to rank results determined by the query manager. Additionally, the score booster 960 may be employed by the query manager 940 in determining the ranking. The score booster allows additional scores for different information to be passed into the query manager and then be added to the document score determined by the query manager. In this way, certain information and/or certain company documents may be boosted if there are users that want to have one or more data fields be valued by the query manager more highly than usual.

For example the score booster may be used to make the “industries” entry in the company document more important than the other data fields. Consequently, relative to other documents returned from a search of the document index, those documents presenting a stronger match with the “industries” field will appear higher in the listing of search results. For example, if the term leather is entered and a score booster is applied to the industries field, then those company documents including the term leather in the industries field will be ranked higher, than for example, if the term “leather” is found in the company descriptions. The approach may be employed between the documents of different companies as well as between documents relating to the same company.

Comparing the score booster to the index score determined above with regard to FIG. 3, with the index score, the document was ranked based on the content of the document. Documents including the company symbol got 80 points, the company name 40 points, etc. However, when the document is indexed, the index score is static unless the document is changed or re-indexed. The score booster operates on top of the index score to modify the total score based on the criteria that are currently being boosted.

In operation, there is preferably a first query to the document index to determine all documents matching the search criteria based on the index score, and then all returned documents are applied with the score booster to adjust the total document score. The documents are then displayed to the user in order of the adjusted score.

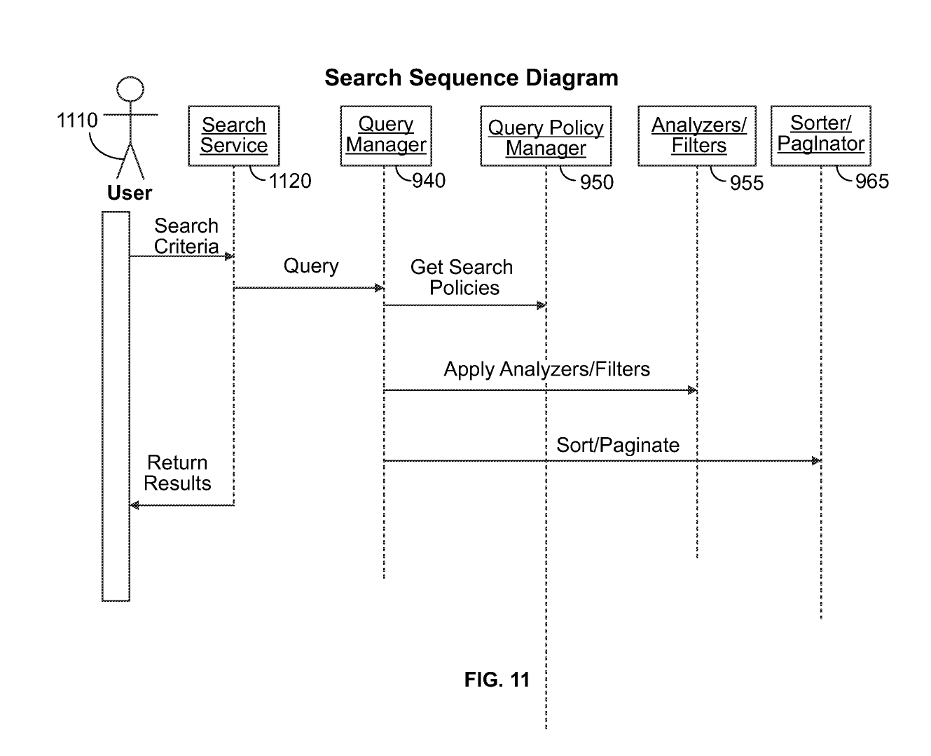

FIG. 11 illustrates the workflow of the query system of FIG. 10. First, a user 1110 enters a search criteria on the web site. The search criteria is then received by a search service 1120 such as a batch service or a standard web processing service. The search service 1120 then passes the query to the query manager 940. As shown in previous figures, the query manager 940 accessed the query policy manager 950 to obtain search policies, then accesses the analyzers/filters 955 and applies them to the search term, then conducts the search of the document index and determines search results. The search results are then sorted and paginated by the sorter/paginator 965. The sorted, paginated search results are then passed from the query manager to the search service and then displayed for the user.

The search service 1120 may be a website, an ASP, or a stand-alone web service which may be implemented on a separate machine on the network. The search service 1120 may also operate as a function call to call the query manager or a web service.

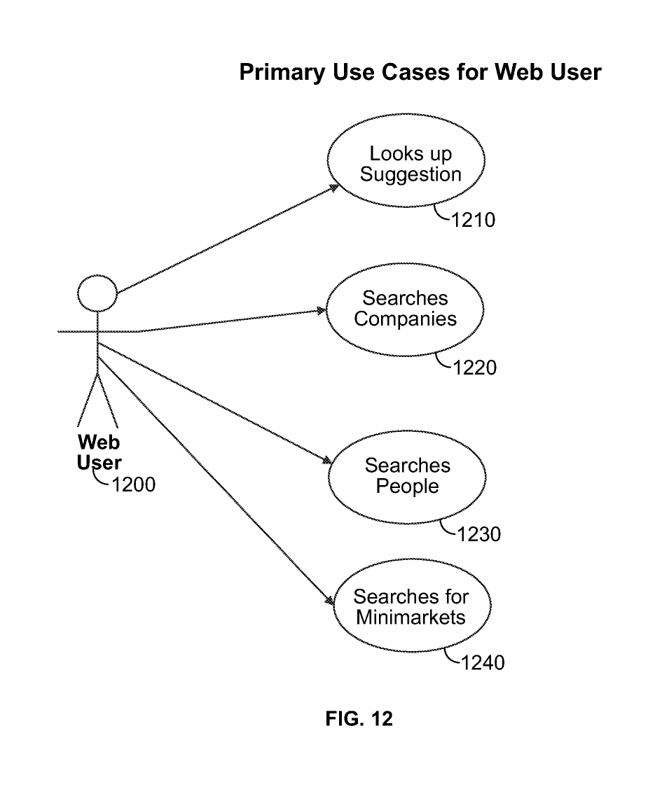

FIG. 12 illustrates a use case for a web user. As shown in FIG. 12, when entering a search, the web user 1200 may look up a suggestion 1210, search companies 1220, search people 1230 such as executives associated with companies, or search for minimarkets 1240 as further described below.

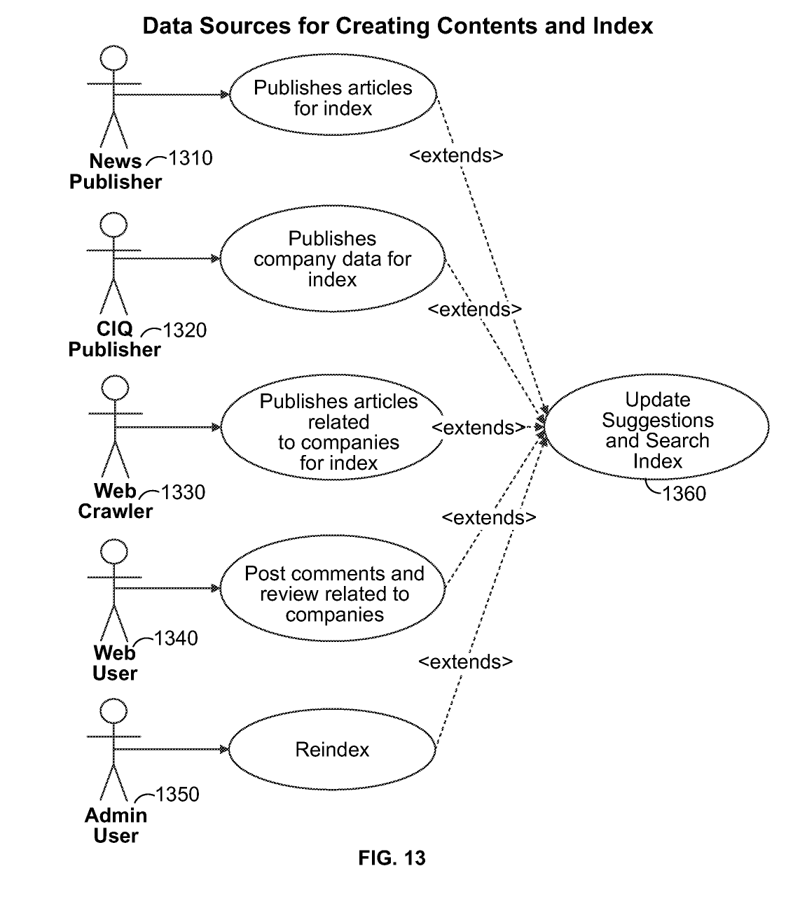

FIG. 13 illustrates the data sources for creating contents and the document index. As shown in FIG. 13, the data sources may include a news publisher 1310 that published articles that are indexed, a corporate information publisher 1320 such as CapitalIQ that publishes company data, a web crawler 1330 that retrieves articles relating to companies, a web user 1340 that posts comments and/or reviews related to the company, and an administrative user 1350 who may enter and adjust index criteria or who may reindex the index. Finally, the index and/or suggestions may be updated using the information from the publishers 1310-1350. Additionally, the recitation of <extends> in the pathway from the publisher to the document index represents the ability of the suggestions and thus the indexing operation to dynamic reconfigure itself based on the received data. In this sense one use case is calling another use case by indexing and suggestions to the search index.

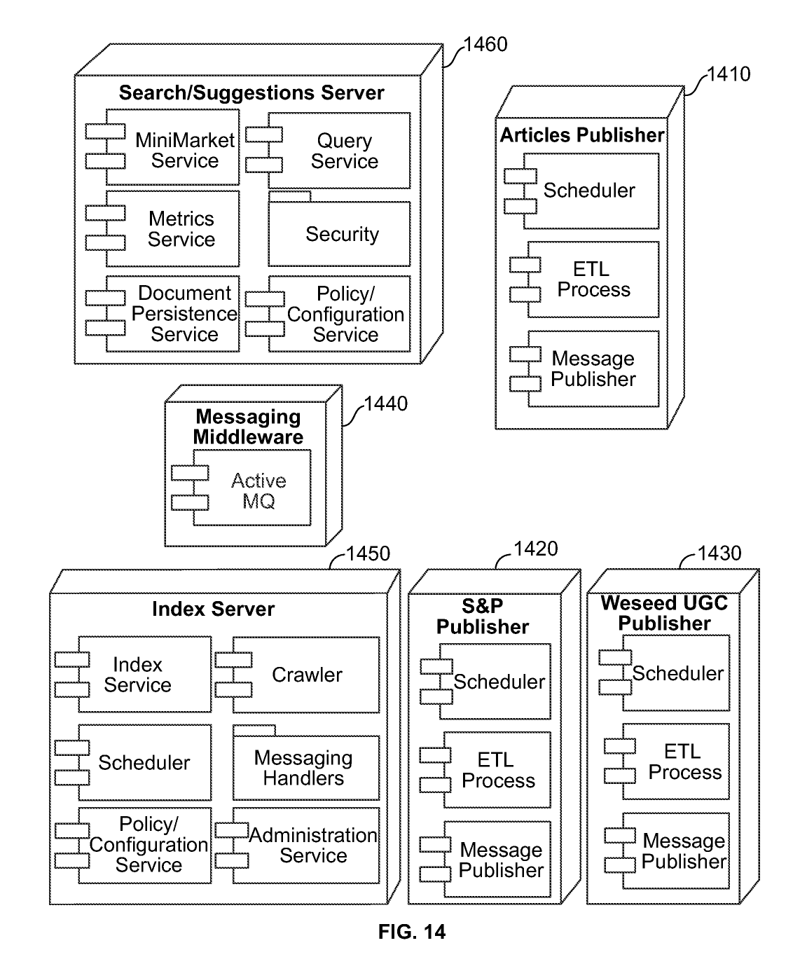

FIG. 14 illustrates an exemplary server and environment layout for the indexing and search systems. The environment includes an articles publisher 1410, a S&P publisher 1420, a User Generated Comment (UGC) publisher 1430, a messaging middleware 1440, an index server 1450, and a search/suggestions server 1460. The articles publisher, S&P publisher 1420 and UGC publisher 130 includes a scheduler that schedules when the process should initiate, as discussed above. Once the schedule initiated the publishing process, the Extract/Transform/Load (ETL) process is initiated and extracts the documents and places them in a preferred form, as discussed above. The publishers then publish the documents as messages to the messaging middleware 1440 using their message publishers.

The messaging middleware 1490 received the messages from the publishers and stores the messages in the active message queue. When the messaging middleware receives a command from the messaging handler at the index server 1450, the messaging middleware 1490 passes the next message in the queue to the index server 1450.

At the index server 1450, the message is received from the publishers and indexed by the index service applying the policy/configuration service. In addition, the index server includes a scheduler for scheduling a web crawler to crawl the web for additional information to index. The administration service is used for making changes to the configuration policy and for debugging. The messaging handles are another way of providing commands and/or data to the index server. Alternatively, the messaging handlers may be user to interact with the messaging middleware to initiate the transfer of the message from the queue at the messaging middleware.

At the search/suggestions server 1460, a user query is passed to the query service which then interacts with the index constructed by the index server to provide relevant documents, as described above. The security module is a password module as discussed above. The policy configuration service has also been discussed above and includes the various suggestion policies. The document persistence service pulls the actual copies of the documents themselves when determined using the index service. The metrics service provides administrative metrics as discussed above. The minimarket service will be further discussed below and provides minimarket data to a user in response to a search.

Turning now to the explanation of the minimarket, the minimarket relates companies to a term, preferably a real world term. Conceptually, minimarkets can allow users to organize relationships between companies and concepts that make sense to them rather than grouping companies my market size or industry, for example. One aspect of minimarkets is enabled by the indexing and search system described above in that terms are being related back to companies as part of the document indexing process. However, minimarkets can build from these automatically determined relationships to allow users to define a minimarket in a way that is more user defined. Additionally, the minimarkets allow an automatic association or to allow end users to associate concepts, key words and/or more real world usage type scenarios to companies as opposed to traditional groupings.

For example, users may input a concept like “leather” and a minimarket of associated companies may be returned, including companies such as Coach or Timberland, for example. Another example of a minimarket might be green companies or raw materials, or other general concepts. Because we have created a search that already establishes a relationship between several companies and a common word or term, the minimarket publicizes or solidifies that association and making it a more recognizable association.

In one embodiment, end users may put these mini-markets together by entering a key word and having the system aggregate associated companies into a minimarket, but then allow the user to prune the listing to remove or add companies that the user feels are relevant. Additionally, a minim-market may be established by the geographic and/or spatial location of the companies.

As another example, a user may insert the term “World of Warcraft”, which is an online video game produced by Blizzard and Blizzard is produced by Sierra Online, who in turn may have arrangements with Intel with regard to chip sets. Additional Nvidia makes high-end graphics cards that may be preferred by garners playing World of Warcraft. Further Nividia and other companies mentioned above may have a relationship with Dell. Consequently, each of these companies would be aggregated into a minimarket that would be automatically provided to a used attempting to assemble a minimarket based around the term “World of Warcraft.”

Additionally, the present indexing and searching system may provide real time dynamic relevance. That is, after the index has been constructed and while the search system is running, an administrator may load or update a policy that applies when indexing a document. For example, the policy may impact the relative weightings of the fields and/or the data sources, which would allow, for example, one field to be weighted more heavily relative to another with regard to the score associated with a document. Such a change in policy is dynamic because it may be added so that the score of the indexed document need note be changed in the index, but that the index score may be adjusted at the time when the document is queried. Consequently, a previously indexed and scored document and/or set of documents may be on the result list of a query, but then the scores associated with the document may be boosted or adjusted based on a policy that is alterable by an administrator—typically without having to re-index and re-score all of the documents in the document index database. Thus, the document may be dynamically re-scored based on boosting a variable such as the company information or industry and the order of the listing of returned documents may change based on the boosted score.

Additionally, the configuration polices are preferably implemented in the present system so that an administrator may change the scoring for one or more factors will be searched on at run time without having to change the code. This is implemented by storing policies separately from the code. One of the drawbacks of previous systems was that scoring policies (if any) and the code were physically dependent so that policies could not be changed without changing the code, which represents a major undertaking.

In an alternative embodiment, one or more embodiments of the present invention include an application wherein the stock market, or certain stocks available in one or more stock markets, are grouped to form a mini-market. The mini-market grouping is determined by the potential interest of a person who may wish to invest in one or more stocks in the mini-market.

For example, a user may have an interest of “gaming”, such as console or PC gaming, for example. Consequently, a mini-market may be assembled that includes gaming-related stocks. The stocks in the mini-market differ from traditional stock groupings because the mini-market includes not just the stocks of the companies that publish or distribute games for gaming, but include the stocks of companies that produce products that may be of interest to someone who actually engages in gaming—including companies that make hardware and infrastructure that supports gaming.

For example, the companies included in the Gaming mini-market may include:

Game Developers or Publishers such as: Microsoft, Nintendo, Activision, Electronic Arts, Konami, TakeTwo Interactive Software, Midway Games,

Gamer hardware and/or infrastructure providers such as: Dell and Sony which may build computers for game playing or consoles for game playing; Activision, which may provide infrastructure such as a MMORPG like Warcraft

Developers of equipment to increase the game experience, such as: Nvidia and THQ.

Retail establishments that sell games, such as: Best Buy, Game Stop, and Circuit City Stores. Additionally, garners may obtain equipment through e-bay, and consequently e-bay may also be included.

As seen from the examples above, the companies included in the Gaming mini-market include a diverse array of companies from several different segments of the traditional stock market. For example, the traditional stock market groups companies based on the type of company—hardware provider with hardware provider and retailer with retailer. Conversely, the mini-market grouping rejects the segmentation of the stock market by company type and instead segments the stock market based on the consumer interest and/or the consumer experience. Another way to describe this segmentation is that the mini-market reflects a stock market that is segmented based on a user experience, desire, or passion.

In operation, one or more mini-markets may be useful in an online stock market trading system. Such a stock trading system may be set up to perform actual cash trades in securities or may be set up to perform simulated trades in securities as a trainer or experiential exercise.

In such an online system, a user may select a desired mini-market. When the mini-market is selected, the companies included in the mini-market are preferably displayed. Further, the system preferably allows the user to trade in one or more of the individual stocks of the mini-market. A user need not purchase all of the stocks in the mini-market and the purchase decision preferably rests with the user. The mini-market display may serve as a filter to present stocks to the user that may be relevant to the particular experience embodied in the mini-market, such as Gaming, for example.

In addition to allowing the user to trade the stocks in the market, the system preferably displays for the user the number and cash value of the securities that the user has previously purchased, as well as the performance of the securities on a daily basis and since purchased by the user. Additionally, the shares purchased today and the overall number of trades that the user has made may be displayed.

Additionally, the mini-market may provide a forum so that investors interested in a particular mini-market may comment and interact, for example with regard to stocks, in the mini-market, purchases or securities, or other subjects of interest to the investors.

Additionally, the mini-market may display all or a subset of trades in the stocks of the mini-market that have been made through the mini-market. In this fashion, the observers of the mini-market may get a feel for the general interest and volume of trades in the securities in the mini-market. Also, the actual trades may include an identifier indicating which user made the trades so that the investors or potential investors may interact or comment with regard to a specific trade situation. Of course, numeric values for trade volume, frequency, and dollar amount may be displayed.

Additionally, access to the mini-market may be password or identity protected. Alternatively, a potential member of the mini-market may be allowed to see some information related to the mini-market, such as the companies in the mini-market, but may be prohibited from seeing information with regard to comments and trades. Such information may be limited to members only.

Additionally, an investor may choose to make their portfolio visible to those observing the mini-market, for example to other members that have logged in. The other investors may monitor the portfolio of the first investor and may question the first investor or comments when the first investor makes a trade. Additionally, the system may be configured to send an alert to a second investor whenever a first investor makes any changes to their portfolio.

Additionally, a picture, image, or video associated with the mini-market may displayed, for example at the time the companies in the mini-market are displayed. In the example were an image is displayed, the image may include one or more icons or click-points. Each icon may be associated with one or more of the companies in the mini-market. Further, one or more of the icons may be positioned over a product or action associated with a specific company, and then may be clicked on to bring up a trading window with regard to that company.

For example, in the gaming mini-market, a picture that includes an Xbox may be displayed, and the Xbox may have an icon positioned over it in the image. When a user clicks on the icon, the user may be directed to Microsoft, the manufacturer of the Xbox, in on or more ways. For example, a new window may open that displays information with regard to Microsoft and/or gives the user an opportunity to trade in the stock of Microsoft. Alternatively, if the listing of companies in the mini-market is already displayed, then the company associated with the icon may be highlighted in the listing or otherwise displayed in a way to draw the user's attention to the company.

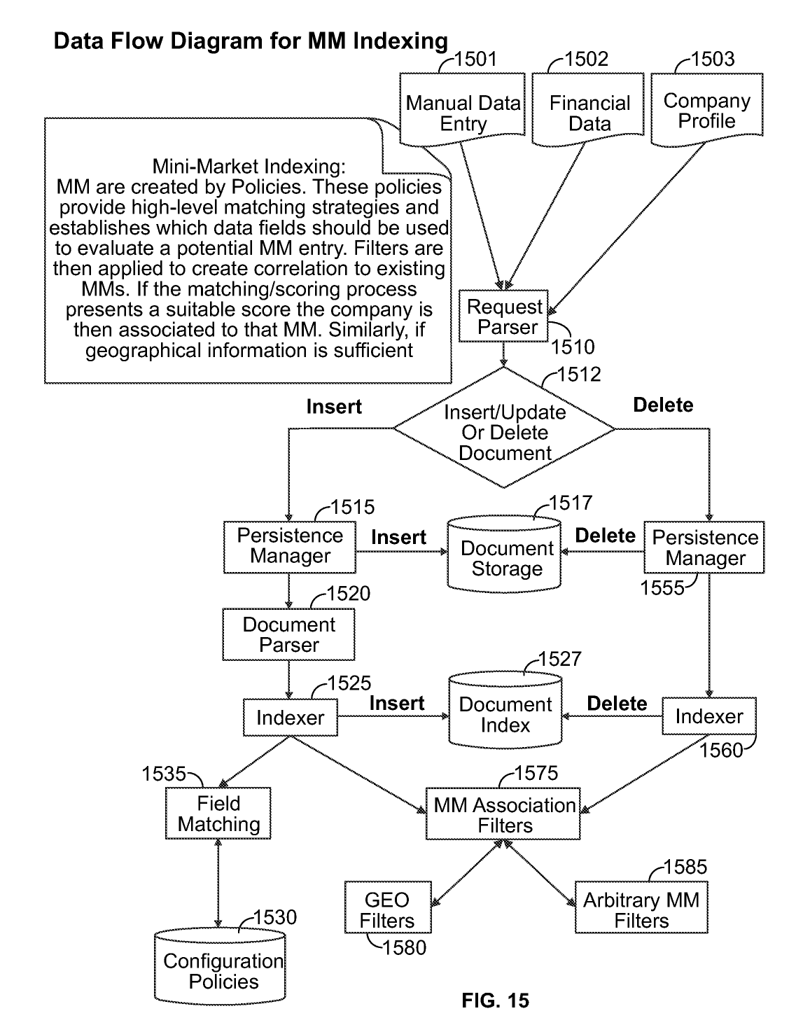

FIG. 15 illustrates a data flow diagram for minimarket indexing according to a preferred embodiment of the present invention. As recited in FIG. 15, in one embodiment minimarkets are created by policies. These policies provide high-level matching strategies and establish which data fields should be used to evaluate a potential minimarket entry. Filters are then applied to create correlation to existing minimarkets. If the matching/scoring process presents a suitable score, the company is then associated with that minimarket. Similarly, if geographic information is sufficient to establish a match, the company is then assigned to a geographic minimarket.

As shown in FIG. 15, data sources such as manual data entry 1501, financial data 1502, and company profiles 1503 are passed to the request parser 1510. The request parser 1510, insert/update or delete decision 1512, persistence managers 1515 and 1555, document storage database 1517, document index database 1527, document parser 1520, and indexers 1525 and 1560 perform in generally the same fashion as those discussed above with regard to FIG. 1.

However, FIG. 15 includes a field matcher 1535 that operates under the control of policies from the configuration/policies database 1530 and interacts with the indexer to identify which fields of the company document retrieved from the document index database 1527 are to be used for construction of the minimarket.

Additionally, FIG. 15 shows the minimarket association filters 1575 that receive input from the geographical location filters 1580 and arbitrary minimarket filters 1580. These filters establish the relationships that are used to determine the association of a specific company with a specific minimarket.

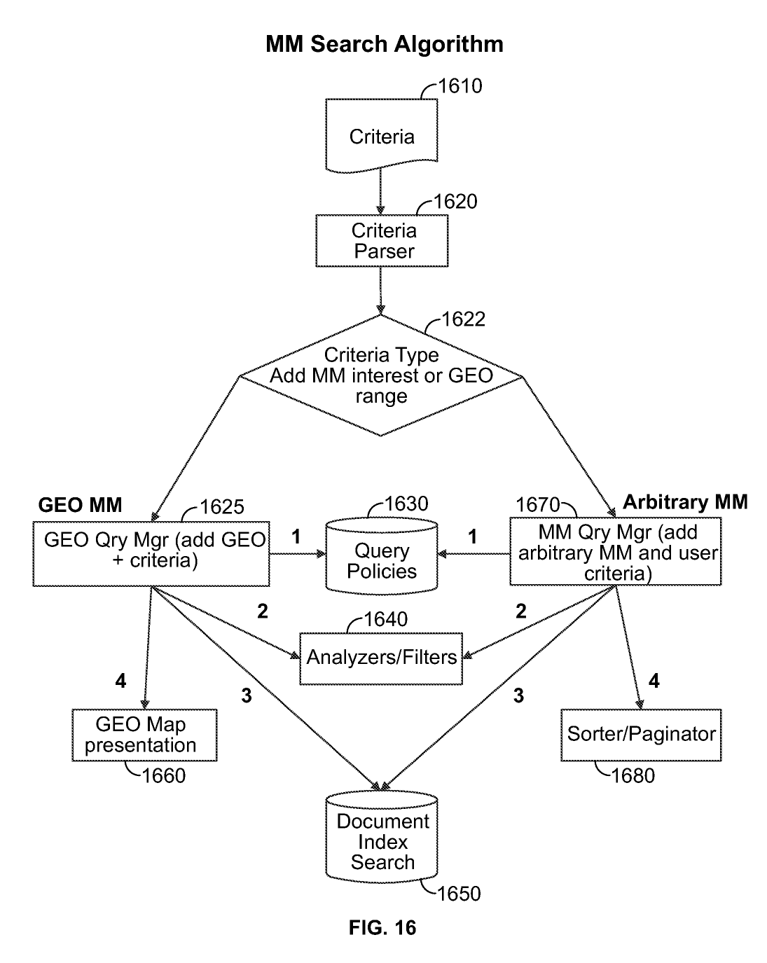

FIG. 16 illustrates a minimarket search algorithm. First, at 1610, a criteria is received from a user and passed to the criteria parser 1620 which determines whether the criteria relates to a minimarket interest or to a geographic range 1622. If the query related to a geographic range, then control passes to a geographical query manager 1625 which also receives the geographical criteria. Next, the relevant policies are retrieved from the query policies database 1630. Then the analyzers/filters 1640 are used to query company documents form the document index search database 1650 with regard to potentially matching the geographic criteria. Finally the results (if any) are presented in a geographic map presentation 1660.

Conversely, if the criteria related to a minimarket interest, then control passes to the arbitrary minimarket query manager 1670 which applies the user criteria to predetermined minimarkets to determine whether there is a match. If one or more matches are detected, the matches are then sorted, paginated, and displayed 1680.

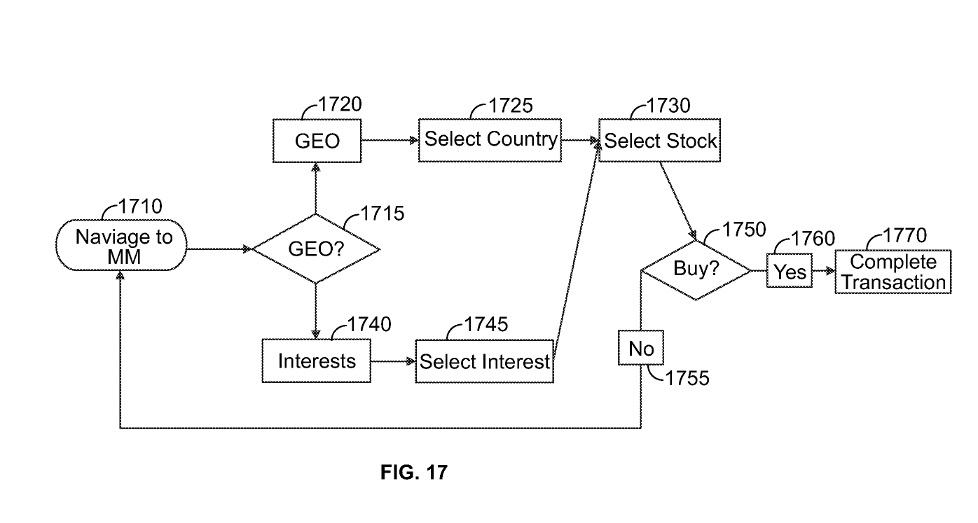

FIG. 17 illustrates the use of the minimarket concept in selecting and purchasing a stock. First, at step 1710, a user navigates to the minimarket portion of the website. The user may then select 1715 whether the desired minimarket is a geographical minimarket. If the minimarket is a geographical minimarket, then control proceeds to the geographic processing block 1720. The user then proceeds to select a country 1725, and then all companies associated with the minimarket representing that country may be displayed. Note that the companies associated with a minimarket for a country need not be national companies of the specific country. For example, certain African countries may be associated with large oil companies due to the significant presence of the oil company in the local economy.

Conversely, if the user does not select the geographic minimarket, then control proceeds to the interests minimarket processing block 1740 wherein the user selects a minimarket based on user interested 1745.

Regardless of whether the minimarket is geographic or user-interest, once the companies in the minimarket are displayed, the user then proceeds to select one of the companies and is then queries as to whether the user would like to buy stock in that company at step 1750. If the user does not wish to purchase stock at step 1755, then the process proceeds back to step 1710 at the entrance to the minimarket area on the website.

Conversely, if the user does wish to purchase stock at step 1760, then the process proceeds to step 1770 and the purchase transaction is accomplished. Preferably the purchase transaction is accomplished by trading/brokerage software operated by the assignee of the present application.

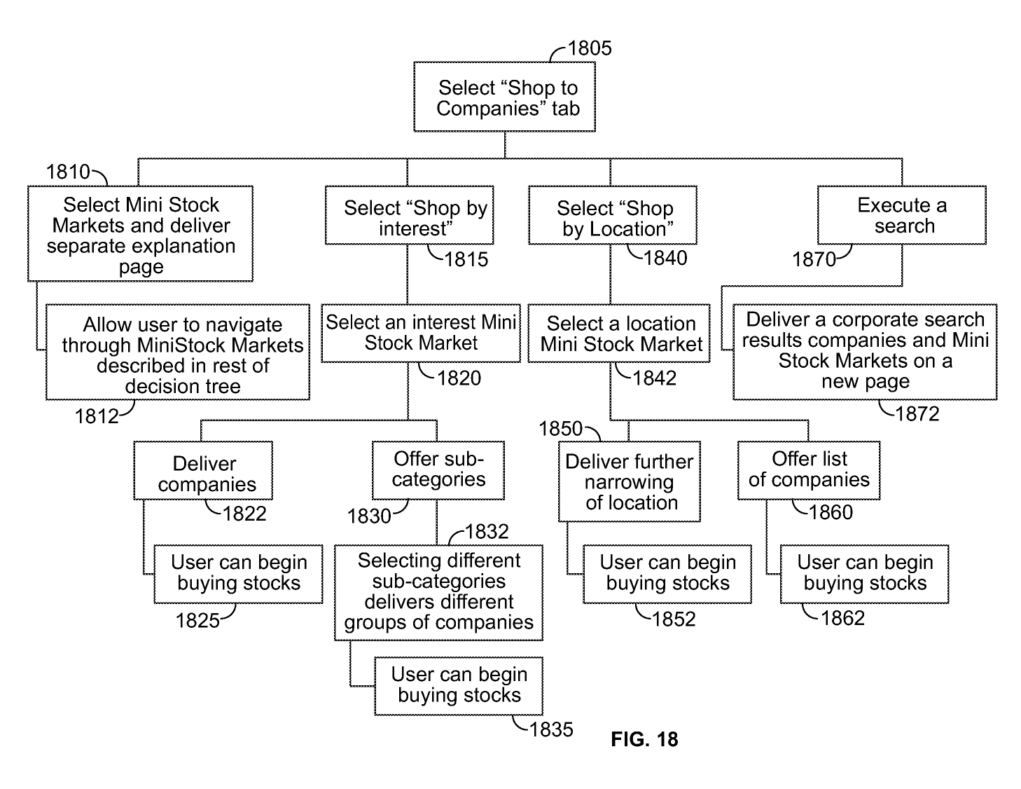

FIG. 18 illustrates an implementation of the minimarket concept on a website. First, at step 1805, a user may select a “shop for companies” tab. The user may then be offered the following option: a first option 1810 wherein a user selects “mini stock markets” and a separate explanation is provide on a separate page; a second option 1815 wherein a user selects that they want to “shop by interest”; a third option 1840 wherein a user selects that they want to “shop by location”; and a fourth option 1870 wherein a user decides to execute a search.

When a user selects the first option, the user at 1812 may be provided with information and may then be allowed to navigate through mini stock markets as described in the other aspects of the decision tree shown in FIG. 18.

When a user selects the second option 1815, the user then selects one of the available interest mini stock markets at 1820. The process then proceeds to either deliver companies 1822 associated with the minimarket and allow the user to begin buying their stock at 1825, or else proceeds to offer sub-categories 1830 to the user. If sub-categories are offered 1830, then the user proceeds to selects a subcategory 1832, which then causes the display of the companies in the subcategory, and the user may then begin buying stocks 1835.

When a user selects the third option 1840, the user is then prompted to enter a location for the location mini stock market. At that point the process then proceeds to either offer a list of companies associated with that geographic location at step 1860 and allow a user to being buying stocks 1862, or else prompts the user to further narrow the geographic location 1850. Once the geographic location is sufficient, the user may then select a company and begin buying stocs 1852.

When a user selects the fourth option, a search is executed 1870, and appropriate search results including companies and ministock markets are displayed on a new page.

Thus, the use of minimarkets is a compelling way to get users engaged and interested in trading shares, as well as helping them locate the shares that they actually wish to trade. The minimarkets aggregate companies and display them in this way—grouped by markets, or common themes—from biotech to fashion to many things in between. Mini Stock Markets are not just meant to group companies, but also to serve as a way for users to find stocks they are interested in based on what they already know and love.

Mini Stock Markets offer the following: 1) Clean and clear presentation:—a key way of finding stocks to trade-in a clean and clear format, that is easy for customers to understand and engage with. 2) Easy to find and pick stocks: users “shop” for companies with ease—this is a common online behavior that maps well to a shopping concept.

Another example of the implementation of minimarkets on a website is now described. Starting from any page on the site, a user selects “Shop for Companies” Tab. The user then opts to search for a company. The user enters company name, ticker symbol, or keyword. The site delivers search results on a new page (<Logo><Company Name><(Symbol)><$Stock Value><$Stock Value Change that day/last trading day> and <Company Fair Price Rating>) as depicted in comps. Search suggestions are displayed (if available), preferably, populating as search term is typed.

If no results found, display text: “Sorry, no results found. Please try again.” Preferably, only 25 search results are displayed at a time (no pagination), but pagination may be alternatively employed. On hover (over entire “slot” for company): “buy” or “buy/sell” button appears. On click of “buy” or “buy/sell” button: if the user is signed in: initiate trade ticket, if the user is not signed in: prompt to sign in, then initiate trade ticket.

On click: the user is navigated to company page. After investigating the company, user may opt to navigate back to search results to continue looking using the “back” button on their browser.

As another option, instead of searching for a company, a user may opt to browse through minimarkets to find companies to invest in. If so, the user clicks on “Mini Stock Markets (MSM)” and is navigated to a separate page that explains function of MSMs. The user may also click on “What do you love?”, and if so the user is taken to separate page that delivers 14 MSMs based on interest.

While on that page, on hover: any available sub-categories display. If sub-category is clicked, the user navigated to results page similar to search results, at which point the Site delivers search results on a new page (<Logo><Company Name><(Symbol)><$Stock Value><$Stock Value Change that day/last trading day> and <Company Fair Price Rating>) as depicted in comps. As above, preferably only 25 search results displayed at a time, paginated if more companies are available (clicking on pagination button takes user to a unique URL page). Further, if user navigates to a company page, they can return to results page using “back” button on browser

If the user clicks instead of hovers, the user is navigated to a results page similar to the search results. Site delivers search results on a new page (<Logo><Company Name><(Symbol)><$Stock Value><$Stock Value Change that day/last trading day> and <Company <Company Fair Price Rating>) as depicted in comps. Again preferably only 25 search results displayed at a time, paginated if more companies are available (clicking on pagination button takes you to a unique URL page).

On hover (over entire “slot” for company): “buy” or “buy/sell” button appears. On click of “buy” or “buy/sell” button, if the user is signed in: initiate trade ticket. If the user is not signed in: prompt to sign in, then initiate trade ticket.

On click: navigates to company page. After investigating company, user opts to navigate back to search results to continue looking using the “back” button on their browser

If instead of clicking on “shop for companies” of browsing MSMs, the user clicks on “Where do you live?”, the site displays new page with map of United States States On hover: display state name (if available # of companies w/I state).

On click: user navigated to results page similar to the search results: Site delivers search results on a new page (<Logo><Company Name><(Symbol)><$Stock Value><$Stock Value Change that day/last trading day> and <Company <Company Fair Price Rating>) as depicted in comps. Preferably, only 25 search results displayed at a time, paginated if more companies are available (clicking on pagination button takes you to a unique URL page)

On hover (over entire “slot” for company): “buy” or “buy/sell” button appears. On click of “buy” or “buy/sell” button, if the user is signed in: initiate trade ticket. If the user is not signed in: prompt to sign in, then initiate trade ticket.

On click: navigates to company page. After investigating company, user opts to navigate back to search results to continue looking using the “back” button on their browser

Cities/Major Metropolitan Locations:

Preferably cities listed to the right of the United States state-based map, in static list of 10. On click: user navigated to results page similar to the search results: Site delivers search results on a new page (<Logo><Company Name><(Symbol)><$Stock Value><$Stock Value Change that day/last trading day> and <Company <Company Fair Price Rating>) as depicted in comps. Preferably, only 25 search results displayed at a time, paginated if more companies are available (clicking on pagination button takes you to a unique URL page)

On hover (over entire “slot” for company): “buy” or “buy/sell” button appears. On click of “buy” or “buy/sell” button, if the user is signed in: initiate trade ticket. If the user is not signed in: prompt to sign in, then initiate trade ticket.Signed in: initiate trade ticket

On click: navigates to company page. After investigating company, user opts to navigate back to search results to continue looking using the “back” button on their browser

User Clicks on Button with Globe & “International” Displayed

Site navigates to separate page displaying entire globe divided into only continents. On hover: display location name (i.e. Europe, Asia). On click: user navigated to results page similar to the search results: Site delivers search results on a new page (<Logo><Company Name><(Symbol)><$Stock Value><$Stock Value Change that day/last trading day>) as depicted in wire frames. Preferably only 25 search results displayed at a time, paginated if more companies are available (clicking on pagination button takes you to a unique URL page).

On hover (over entire “slot” for company): “buy” or “buy/sell” button appears. On click of “buy” or “buy/sell” button, if the user is signed in: initiate trade ticket. If the user is not signed in: prompt to sign in, then initiate trade ticket.Signed in: initiate trade ticket

On click: navigates to company page After investigating company, user opts to navigate back to search results to continue looking using the “back” button on their browser

Special case: User selects “North America”, search results delivered are all North American countries EXCEPT for United States (Canada, Mexico, Caribbean Islands, Guatemala, Belize, Honduras, El Salvador, Nicaragua, Costa Rica, Panama)

User clicks on button with map of US and “The United States” on it, site navigates to page displaying only the map of United States

Interest Mini Stock Markets which include sub-categories (“What do you love?”) such as Cars & Vehicles, Entertainment, Environment, Family & Kids, Fashion, Food, Health & Wellness, Home & Garden, Outdoors & Leisure, Pets & Animals, Sports, Tech, Teens, and Travel.

Location Mini Stock Markets (“Where do you live?”), preferably display as a map, default value US, but allow for international browsing. In the US, states and region/city areas such as the following are examples: New York Chicago San Francisco Los Angeles Dallas Philadelphia Washington Boston Atlanta, and Minneapolis. International preferably includes the following regions and the countries therein: North America (all countries north of & incl. Panama), Africa (South of Mediterranean, west of Suez Canal (includes ALL of Egypt) and any nearby islands), South America (Defined as all countries south of Panama), Asia (Includes Russia, many islands between mainland Asia, Australia, and North America), Europe (Any countries west of Russia, north of Mediterranean, north/west Black Sea, Aegean Sea), Middle East (Arabian Peninsula), and Oceana

Additionally, the MSM display provides a display of any subcategories (all clickable) for that Mini Stock Market (i.e. Entertainment Mini Stock Market would include Movies, TV, Books, Video Games) in drop-down menu at the top of the page. If a subcategory is clicked, user is taken to a new page that lists all companies contained in that subcategory, able to be sorted by Name, Ticker, Share Value, and Gain/Loss.

When an Occupation Mini Stock Market (Industry) is selected (i.e. Auto & Vehicles): 1) List the occupations under that industry (i.e. Parts, Dealership & Sales, Manufacturing, etc) in same visual interface as listing the industries to chose from (Once occupation is selected, list companies as before); and 2) Offer full list of companies in that Mini Stock Market

When an Location Mini Stock Market is selected (i.e. America, Asia): 1) List the regions under that location (i.e. states, countries, etc) in maps-based visual interface (when possible) (Once narrowest location option is selected, list companies as before), and 2) Offer full list of companies in that Mini Stock Market & subcategories

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A system for searching, said system including:
an indexing system receiving original documents of a plurality of document types and constructing index documents including a plurality of document fields based on information contained in said original documents,
wherein said original documents are stored in an original documents database,
wherein said index documents are stored in an index documents database,
wherein one of said fields is a minimarket field representing a grouping of companies based on a user interest; and
a search system wherein a search entered by a user is used to find a plurality of index documents matching said search term and then a plurality of original documents associated with the index documents are returned to said user as search results.
